(19) United States
(12) Patent Application Publication
(10) Pub. No.: US 2025/0093097 A1
(43) Pub. Date: Mar. 20, 2025

(54) Drying Apparatus

(71) Applicant: SK On Co., Ltd., Seoul (KR)

(72) Inventors: Yun Jong Kim, Daejeon (KR); Dae Hee Kim, Daejeon (KR); Dong Young Jung, Daejeon (KR)

(21) Appl. No.: 18/884,180

(22) Filed: Sep. 13, 2024

(30) Foreign Application Priority Data
Sep. 14, 2023 (KR) 10-2023-0122657

(51) Int. Cl. F26B 21/00; F26B 3/04; F26B 3/30

(52) U.S. Cl. CPC F26B 21/004; F26B 3/04; F26B 3/30

(57) ABSTRACT

A drying apparatus includes an upper drying part including a first drying nozzle which is formed above an object to be dried and which extends along a width direction of the object, the upper drying part including a second drying nozzle formed on a same surface as the first drying nozzle. Furthermore, the drying apparatus includes a lower drying part including a lower drying nozzle which is formed below the object and which extends along the width direction of the object. The first and second drying nozzles are configured to dry the object with different heat sources. There is an effect that the drying deviation of the object may be minimized and the precision of the drying may be increased by effectively preventing the overdrying or non-drying of the object during the drying of the object.

### CROSS REFERENCE TO RELATED APPLICATION

This application claims priority to Korean Patent Application No. 10-2023-0122657 filed Sep. 14, 2023, the disclosure of which is hereby incorporated by reference in its entirety.

### BACKGROUND

### Technical Field

The present disclosure relates to a drying apparatus.

### Technical Considerations

Recently, miniaturization and weight reduction of a mobile information terminal such as a mobile phone, a notebook, and so on are implemented. Furthermore, various batteries are developed and used as power sources since a high capacity is required in an electric vehicle, a hybrid vehicle, and so on. In such an electrode plate used in a secondary battery, a capacitor, and so on, electrode powder and so on have been applied and dried on a surface of a support body in a slurry form, thereby producing the electrode plate.

In a manufacturing process of such an electrode plate, a drying chamber facility as described in JP 2014-231950 A has been used to dry a solvent in a slurry that is sprayed on a support body, and there have been various attempts to improve the drying quality such as the drying efficiency, the drying deviation, and so on by a conventional heat source.

### SUMMARY

According to a non-limiting aspect of the present disclosure, there is provided a drying apparatus for minimizing the drying deviation during the drying of an object to be dried.

According to another non-limiting aspect of the present disclosure, there is provided a drying apparatus capable of individually controlling the drying temperature during the drying of an object to be dried and also capable of effectively controlling residual heat at the time of on/off control of the drying apparatus.

According to a non-limiting aspect of the present disclosure, there is provided a drying apparatus including: an upper drying part including a first drying nozzle which is formed above a object to be dried and which extends along a width direction of the object to be dried, the upper drying part including a second drying nozzle formed on a same surface as the first drying nozzle; and a lower drying part including a lower drying nozzle which is formed below the object to be dried and which extends along the width direction of the object to be dried, wherein the first drying nozzle and the second drying nozzle are configured to dry the object to be dried with different heat sources.

Here, the first drying nozzle may include a hot air heater, and the second drying nozzle may include an infrared heater.

In addition, the second drying nozzle may include at least one second division nozzle divided along the width direction of the object to be dried.

In addition, the lower drying nozzle may be formed in a direction facing the first drying nozzle.

In addition, the drying apparatus may further include a shielding adjustment part formed between the object to be dried and the upper drying part, the shield adjustment part including: a guide rail formed in a width direction and a longitudinal direction of the upper drying part; and a shielding plate configured to shield a portion or all of a space between the object to be dried and the first drying nozzle or between the object to be dried and the second drying nozzle along the guide rail.

In addition, the shielding plate may be formed such that at least one shielding plate configured to shield a first end or a second end of the object to be dried by being moved in a longitudinal direction of the second drying nozzle is provided.

In addition, the shielding plate may be formed such that a width of the shielding plate is larger than a width of the first drying nozzle or a width of the second drying nozzle.

In addition, a width of the first drying nozzle may be formed from 150 mm to 250 mm, a width of the second drying nozzle may be formed from 130 mm to 180 mm, and a width of the lower drying nozzle may be formed from 150 mm to 250 mm.

In addition, the second drying nozzle may include a second division nozzle that is divided as a plurality of second division nozzles in the width direction of the object to be dried, may include a second single nozzle integrally formed in the width direction of the object to be dried, and the second single nozzle and the second division nozzle may be alternately formed between each first drying nozzle.

In addition, the plurality of second division nozzles may be individually controlled for each position according to a drying state of the object to be dried.

In addition, the plurality of second division nozzles may be formed by being spaced apart from each other, the second division nozzles may be formed so as to respectively correspond to a first side and a second side of the first drying nozzle, and the plurality of second division nozzles formed on a direction in the first side of the first drying nozzle may be simultaneously controlled to be operated with a same output and the plurality of second division nozzles formed on a direction in the second side of the first drying nozzle may be simultaneously controlled to be operated with a same output.

In addition, a length of the first drying nozzle in the width direction of the object to be dried may be formed 1.5 times to 2 times a length of the second division nozzle in the width direction of the object to be dried.

According to another non-limiting aspect of the present disclosure, there is provided a drying apparatus including an upper drying part including a first drying nozzle which is formed above an object to be dried and which extends along a width direction of the object to be dried, the upper drying part including a second drying nozzle which is formed on a same surface as the first drying nozzle and which is formed of a heat source different from the first drying nozzle, wherein the second drying nozzle includes a single drying nozzle on a first side in the width direction of the object to be dried and a multi-drying nozzle on a second side in the width direction of the object to be dried, and the single drying nozzle and the multi-drying nozzle are formed such that the single drying nozzle and the multi-drying nozzle are alternately arranged on the first side and the second side in a longitudinal direction of the object to be dried.

Here, the second drying nozzle may be arranged alternately with the first drying nozzle, the single drying nozzle and the multi-drying nozzle that are formed in the first side in the width direction of the object to be dried along a first direction may be controlled to be operated with a same output, and the single drying nozzle and the multi-drying nozzle that are formed in the second side in the width direction of the object to be dried along the first direction may be controlled to be operated with a same output.

In addition, the single drying nozzle may include a single infrared heater and the multi-drying nozzle may include at least two infrared heaters, and the single drying nozzle and the multi-drying nozzle may be formed by a same distance in a moving direction of the object to be dried.

The features and advantages of the present disclosure will be more clearly understood from the following detailed description based on the accompanying drawings.

The terms and words used in the present specification and claims should not be interpreted as being limited to typical meanings and dictionary definitions, but should be interpreted as having meanings and concepts relevant to the technical scope of the present disclosure based on the rule according to which an inventor can appropriately define the concept of the term to describe most appropriately the best method he or she knows for carrying out the present disclosure.

According to non-limiting embodiments of the present disclosure, there is an effect that the drying deviation of the object to be dried is capable of being minimized and the precision of the drying is capable of being increased by effectively preventing the overdrying or non-drying of the object to be dried during the drying of the object to be dried.

In addition, in addition to being able to effectively control the drying temperature of the object to be dried, there is an effect that the drying degree of is capable of being effectively controlled by physically blocking residual heat when the drying apparatus is turned on/off.

In addition, since the drying degree according to the position of the object to be dried is capable of being appropriately adjusted when the object to be dried is dried, there is an effect that the limitation of the physical drying area of the drying apparatus is capable of being effectively overcome.

In addition, when the object to be dried is dried, the drying nozzles for each location of the object to be dried are provided and each of the drying nozzles is individually controlled, so that there is an effect that the drying deviation of the object to be dried is capable of being minimized.

In addition, by using drying methods by the plurality of different heat sources of the drying apparatus, there is an effect that the drying temperature is capable of being effectively controlled during the drying of the object to be dried.

In addition, by adjusting the physical structure and arrangement of the drying nozzles of the drying apparatus, there is an effect that the drying reliability of the object to be dried is capable of being secured.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a plan view illustrating an upper drying part of a drying apparatus according to a non-limiting embodiment of the present disclosure;

FIG. 2 is a plan view illustrating a lower drying part of the drying apparatus according to a non-limiting embodiment of the present disclosure;

FIG. 3 is a side view illustrating the drying apparatus according to a non-limiting embodiment of the present disclosure;

FIG. 4 is a plan view illustrating the drying apparatus according to a non-limiting embodiment of the present disclosure;

FIG. 5 is a side view illustrating the drying apparatus to which a shielding adjustment part is coupled according to a non-limiting embodiment of the present disclosure;

FIG. 6 is a plan view illustrating the shielding adjustment part according to a non-limiting embodiment of the present disclosure; and

FIG. 7 is a plan view illustrating the upper drying part of the drying apparatus according to a non-limiting embodiment of the present disclosure.

### DETAILED DESCRIPTION

Objectives, advantages, and features of the present disclosure will be more apparent from the following detailed description and exemplary and non-limiting embodiments taken in connection with the accompanying drawings, but the present disclosure is not limited thereto. Furthermore, in the description of the present disclosure, it is to be noted that, when known techniques related to the present disclosure may make the gist of the present disclosure unclear, a detailed description thereof will be omitted.

In adding reference numerals to components throughout the drawings, it is to be noted that like or similar reference numerals designate like or similar components even though the components are illustrated in different drawings.

The terms used in the present disclosure are used to describe an embodiment, and are not intended to limit the present disclosure. Singular expressions include plural expressions unless the context clearly indicates otherwise.

In the present disclosure disclosed herein, the expressions “have”, “may have”, “include” and “comprise”, or “may include” and “may comprise” used herein indicate existence of corresponding features (e.g., elements such as numeric values, functions, operations, or components) but do not exclude presence of additional features.

The terms “one”, “other”, “another”, “a first”, “a second”, and so on are used to distinguish one element from other elements, but the elements should not be construed to be limited by the terms.

It should be understood that the specific embodiments and accompanying drawings according to the concept of the present disclosure are not limited to the embodiments which will be described hereinbelow. All of modifications, equivalents, and substitutions are included in the scope and spirit of the present disclosure.

Hereinafter, non-limiting embodiments of the present disclosure will be further described with reference to specific embodiments and drawings. Embodiments are proposed to more concretely describe the present disclosure. However, the embodiments are only given for illustrating the present disclosure and those skilled in the related art will obviously understand that various alterations and modifications are possible within the scope and spirit of the present disclosure. Such alterations and modifications are duly included in the appended claims.

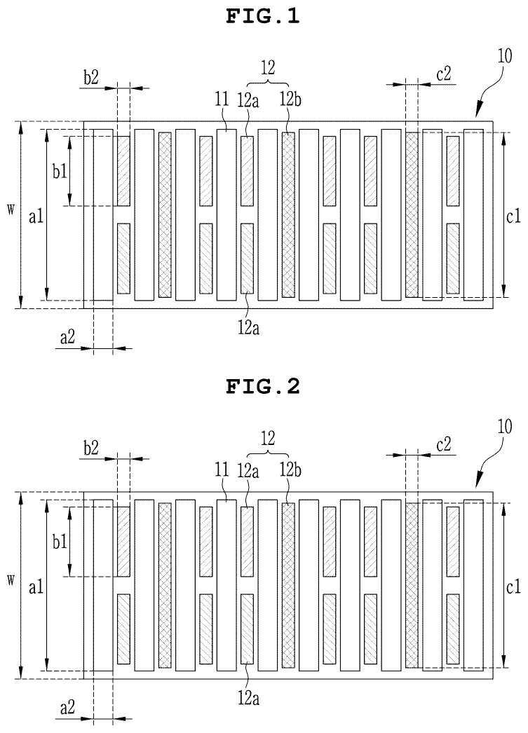

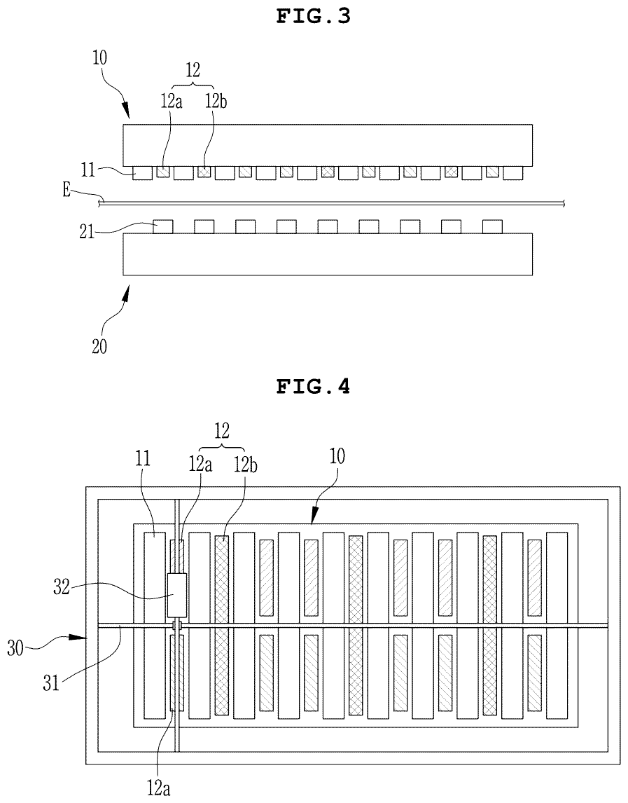

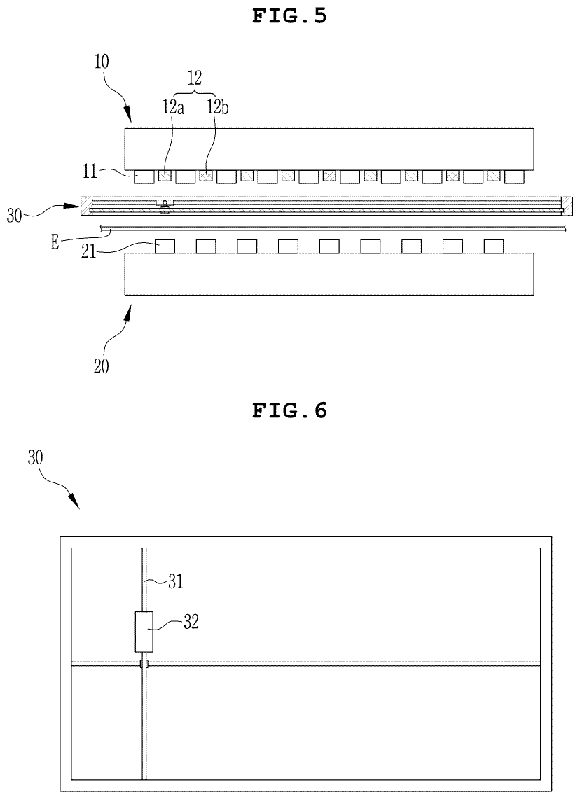

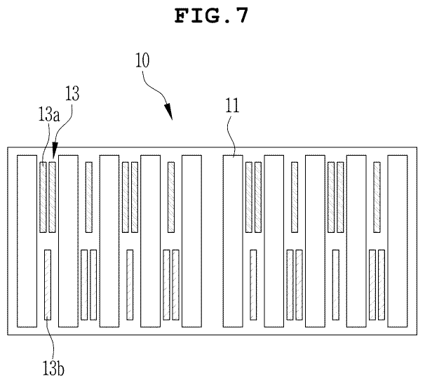

FIG. 1 is a plan view illustrating an upper drying part of a drying apparatus according to a non-limiting embodiment of the present disclosure, FIG. 2 is a plan view illustrating a lower drying part of the drying apparatus according to a non-limiting embodiment of the present disclosure, FIG. 3 is a side view illustrating the drying apparatus according to a non-limiting embodiment of the present disclosure, FIG. 4 is a plan view illustrating the drying apparatus according to a non-limiting embodiment of the present disclosure, FIG. 5 is a side view illustrating the drying apparatus to which a shielding adjustment part is coupled according to a non-limiting embodiment of the present disclosure, and FIG. 6 is a plan view illustrating the shielding adjustment part according to a non-limiting embodiment of the present disclosure.

A drying apparatus according to a non-limiting embodiment of the present disclosure includes an upper drying part 10 having a first drying nozzle 11 which is formed above an object to be dried E and which extends along a width direction w of the object to be dried E and having a second drying nozzle 12 formed on the same surface as the first drying nozzle 11, and includes a lower drying part 20 having a lower drying nozzle 21 which is formed below the object to be dried E and which extends along the width direction w of the object to be dried E. Furthermore, the first drying nozzle 11 and the second drying nozzle 12 may dry the object to be dried with different heat sources.

In the present disclosure, the term ‘object to be dried E’ collectively refers to an object that will be dried, and refers to various objects to be dried in a sheet form. Although drying of an electrode plate in the secondary battery field has been illustrated as an example, the object to be dried E of the present disclosure is not limited to the electrode plate, and the object to be dried E of the present disclosure may be various objects to be dried E for resolving a deviation in the position during drying and for resolving an imbalance of various drying amounts during drying.

As illustrated in FIG. 1, the first drying nozzle 11 and the second drying nozzle 12 may be disposed in a mixed manner on the upper drying part 10 of the drying apparatus according to a non-limiting embodiment of the present disclosure. In the illustrated drawings, the first drying nozzle 11 and the second drying nozzle 12 are alternately formed, but are not limited thereto, and, of course, the first drying nozzle 11 and the second drying nozzle 12 may be disposed in various positions to overcome the drying deviation of the object to be dried E.

The first drying nozzle 11 and the second drying nozzle 12 may dry the object to be dried E by using different heat sources. The first drying nozzle 11 may include a hot air heater and may dry the object to be dried E by a hot air method, and the second drying nozzle 12 may include an infrared heater and may dry the object to be dried E by a radiation method.

In addition to the mixed arrangement of the first drying nozzle 11 and the second drying nozzle 12, by drying the object to be dried E using the first drying nozzle 11 and the second drying nozzle 12 in different methods, a margin of heat source for the object to be dried E may be secured.

The first drying nozzle 11 and the second drying nozzle 12 may be formed such that the first drying nozzle 11 and the second drying nozzle 12 extend in the width direction w in a moving direction of the object to be dried E, and may be disposed to be spaced apart from each other by a predetermined distance. When the object to be dried E is dried, non-drying of both end parts in the width direction w of the object to be dried E or overdrying of a center portion of the object to be dried E may occur. Therefore, the drying heat and the drying position may be adjusted by the first drying nozzle 11 and the second drying nozzle 12.

The second drying nozzle 12 may include the infrared heater using radiant heat, and may be provided as a plurality of second division nozzles 12a formed by a predetermined distance in a longitudinal direction in which the second drying nozzle 12 is formed. As illustrated in the drawings, the plurality of second division nozzles 12a is divided into a first side and a second side along the longitudinal direction of the object to be dried E. That is, the plurality of second division nozzles 12a is divided into an upper portion and a lower portion in the plan view in FIG. 1.

That is, since the plurality of second division nozzles 12a is disposed to be spaced apart from each other in the width direction w of the object to be dried E, the drying temperature, the position, and the drying amount of the object to be dried E in the width direction w by the second drying nozzle 12 together with the drying performed by the first drying nozzle 11 may be appropriately adjusted.

In this case, the second division nozzles 12a may be individually controlled, so that the drying temperature may be adjusted appropriately and the operation of the apparatus for the position may be turned on and turned off appropriately according to the overdried position or non-dried position of the object to be dried E. At this time, the plurality of second division nozzles 12a may be divided into the upper portion and the lower portion respectively in a progression direction of the object to be dried E. In this case, the second division nozzle 12a at the upper portion may be controlled to be operated with the same output by using one control range, and the second division nozzle 12a at the lower portion may be controlled to be operated with the same output by using another control range, so that entire of the plurality of second division nozzles 12a may be controlled to be operated with the same output. In this manner, the division nozzles at the upper portion and the lower portion of the second drying nozzle 12 of the upper drying part 10 may be individually controlled.

In the second drying nozzle 12, together with the plurality of second division nozzles 12a, a second single nozzle 12b, which is similar to the first drying nozzle 11, that is not divided may be arranged in a mixed manner.

Since the second single nozzle 12b and the second division nozzle 12a have different shapes, the drying temperature and so on may be individually controlled for each shape, and the plurality of the second single nozzles 12b may be controlled together to be operated with the same output independently of the second division nozzles 12a.

By appropriately arranging and mixing the drying of first drying nozzle 11 using the hot air method and the drying of the second drying nozzle 12 using the radiant heat method, the drying of the object to be dried E may be controlled more precisely.

On the basis of the length in the width direction w of the object to be dried E, a formation length A1 of the first drying nozzle 11 may be formed 1.5 times to 2 times a length B1 of the single second division nozzle 12a of the second drying nozzle 12. In addition to the first drying nozzle 11 using the basic hot air method, the second drying nozzle 12 capable of more precisely performing control for the position and for the drying temperature may be disposed in a form of the second division nozzles 12a and the second single nozzle 12b. Through a relative ratio of lengths a1, c1, and c2 of the first drying nozzle 11 and the second drying nozzle 12, the drying degree in which the object to be dried E is dried by the plurality of heat sources, the drying temperature, the drying position, and so on may be more precisely controlled. In addition, durability of the drying apparatus may be secured by physically arranging the first drying nozzle 11 and the second drying nozzle 12, and the mutual interference between heat sources occurring due to the using of the different heat sources during the drying process may be minimized, so that the drying deviation may be reduced more precisely.

Here, in order to more effectively prevent non-drying of ends in the width direction w of the object to be dried E and so on, the first drying nozzle 11 and the second drying nozzle 12 may be disposed such that the first drying nozzle 11 and the second drying nozzle 12 cover both ends in the width direction w of the object to be dried E. That is, the first drying nozzle 11 and the second drying nozzle 12 may be respectively disposed such that the second drying nozzle 12 is aligned with the both ends in the width direction w of the object to be dried E when the second drying nozzle 12 is divided into the plurality of second drying nozzles 12. In addition, the plurality of second division nozzles 12a may align each first end of the second division nozzles 12a to the same position by adjusting the distance between the plurality of second division nozzles 12a.

The first drying nozzle 11 and the second drying nozzle 12 may be formed such that the first drying nozzle 11 and the second drying nozzle 12 are spaced apart from each other, a width a2 in the longitudinal direction of the first drying nozzle 11 may be formed from 150 mm to 250 mm, and widths b2 and c2 in the longitudinal direction of the second drying nozzle 12 may be formed from 130 mm to 180 mm.

In order to adjust the drying degree due to the different heat sources, the widths are appropriately adjusted with in the ranges, so that the reliability of the drying effect on the object to be dried E may be increased.

As illustrated in FIG. 2, the lower drying part 20 of the drying apparatus according to a non-limiting embodiment of the present disclosure may include the lower drying nozzle 21 formed parallel to the longitudinal direction of the first drying nozzle 11 or the longitudinal direction of the second drying nozzle 12. The lower drying nozzle 21 is provided as a plurality of lower drying nozzles 21, and each of the lower drying nozzles 21 may be disposed side by side to be spaced apart from each other.

The lower drying nozzle 21 may be disposed such that the lower drying nozzle 21 faces the first drying nozzle 11 or the second drying nozzle 12 of the upper drying part 10, and the lower drying nozzles 21 have widths the same as the widths of the facing drying nozzles, so that the drying deviation on the upper surface and the lower surface of the object to be dried E may be effectively controlled.

The lower drying nozzle 21 may be formed such that the lower drying nozzle 21 has the same width and length as the first drying nozzle 11, and a width d2 in a longitudinal direction of the lower drying nozzle 21 may be formed from 150 mm to 250 mm. The lower drying nozzle 21 may be formed such that a length d1 of the lower drying nozzle 21 corresponds to that of the first drying nozzle 11 facing the lower drying nozzle 21.

As illustrated in FIG. 3, the upper surface and the lower surface of the object to be dried E may be dried through the upper drying part 10 and the lower drying part 20, respectively.

As illustrated in FIG. 4, a separate shielding adjustment part 30 may be disposed between the upper drying part 10 and the object to be dried E. In a situation in which the object to be dried E is dried through the first drying nozzle 11 or the second drying nozzle 12, when a process in which the on/off operation of the drying apparatus for adjusting the drying temperature or the drying amount is performed, the shielding adjustment part 30 may effectively shield the residual heat that lasts for a predetermined time after the apparatus is turned off. Particularly, in the second drying nozzle 12, when the object to be dried E is dried through radiant heat, the physical shielding adjustment part 30 may be used to effectively control the residual heat that lasts for the predetermined time even when the operation is temporarily turned off.

Specifically, as illustrated in FIG. 5 and FIG. 6, the shielding adjustment part 30 may include a guide rail 31 configured to guide driving of a shielding plate 32 in a direction in which the first drying nozzle 11 or the second drying nozzle 12 of the upper drying part 10 is formed. The shielding plate 32 physically blocks a portion of the first drying nozzle 11 or the second drying nozzle 12 through the guide rail 31 as required, thereby preventing the overdrying of the object to be dried E due to the residual heat and so on.

The guide rail 31 may be disposed correspondingly on a separation space between the first drying nozzles 11 or the second drying nozzles 12 in order to minimize interference during the drying process performed by the first drying nozzle 11 or the second drying nozzle 12 while physically moving the shielding plate 32. In addition, of course, the shielding adjustment part 30 may be formed of a material having a low thermal conductivity so that the residual heat generated by the first drying nozzle 11 or the second drying nozzle 12 is not transferred to the object to be dried E.

FIG. 7 is a plan view illustrating the upper drying part of the drying apparatus according to a non-limiting embodiment of the present disclosure.

The drying apparatus according to a non-limiting embodiment of the present disclosure includes the upper drying part 10 having the first drying nozzle 11 which is formed above the object to be dried E and which extends along the width direction w of the object to be dried E and having a second drying nozzle 13 which is formed on the same surface as the first drying nozzle 11 and which is formed of a heat source different from the first drying nozzle 11. Furthermore, the second drying nozzle 13 includes a single drying nozzle 13b on the first side in the width direction of the object to be dried E and a multi-drying nozzle 13a on the second side in the width direction of the object to be dried E, and the single drying nozzle 13b and the multi-drying nozzle 13a may be formed such that the single drying nozzle 13b and the multi-drying nozzle 13a are alternately arranged on the first side and the second side in the longitudinal direction of the object to be dried E.

The first drying nozzle 11 and the second drying nozzle 13 may be formed on the same plane of the upper drying part 10. Drying methods by heat sources different from each other may be applied to the first drying nozzle 11 and the second drying nozzle 13, respectively. In the present disclosure, the drying method performed by hot air may be applied to the first drying nozzle 11, and the drying method performed by the infrared heater may be applied to the second drying nozzle 13.

The second drying nozzle 13 may be arranged alternately with the first drying nozzle 11, or may be applied to all or part structures of the upper drying part 10. Furthermore, in consideration of the drying deviation of the object to be dried E, of course, the arrangement method of the first drying nozzle 11 and the second drying nozzle 13 may be changed appropriately.

As illustrated in FIG. 7, the second drying nozzle 13 may include the single drying nozzle 13b formed of a single infrared heater and may include the multi-drying nozzle 13a formed of at least two infrared heaters.

Of course, the single drying nozzle 13b and the multi-drying nozzle 13a may be formed in a separated shape by being divided from each other in the formation direction of the first drying nozzle 11, and the divided size or the divided shape thereof may be appropriately changed without being limited to the one illustrated.

As illustrated in FIG. 7, the single drying nozzle 13b and the multi-drying nozzle 13a may be alternately formed in the movement direction of the object to be dried E, respectively. That is, the single drying nozzle 13b and the multi-drying nozzle 13a are formed on the first side and the second side in the width direction of the object to be dried E, and are alternately formed in the movement direction of the object to be dried E, so that the overall drying deviation may be reduced by effectively adjusting the drying according to the position of the object to be dried E.

In the upper portion in FIG. 7, the single drying nozzle 13b and the multi-drying nozzle 13a disposed in the movement direction of the object to be dried E along the first side in the width direction of the object to be dried E may be controlled in the same output range by using one control range. In addition, the single drying nozzle 13b and the multi-drying nozzle 13a disposed in the movement direction of the object to be dried E along the second side in the width direction of the object to be dried E may also be controlled in the same output range by using one control range.

In addition, of course, the drying deviation for the entire object to be dried E is capable of being adjusted and controlled by respectively setting a control range such that a control range in which the single drying nozzles 13b are controlled and a control range in which the multi-drying nozzles 13a are controlled are set.

In addition, although the single drying nozzle 13b and the multi-drying nozzle 13a have different numbers of infrared heaters, the distance of the formation space has an equal distance in the movement direction of the object to be dried E, so that the drying degree within the same distance range may be effectively controlled.

The present disclosure has been described in detail through specific embodiments. An embodiment is intended to describe the present disclosure in detail, and the present disclosure is not limited to the embodiment. The present disclosure can be variously modified by those skilled in the art without departing from the scope of the technical idea of the present disclosure.

Furthermore, simple changes and modifications of the present disclosure are appreciated as included in the scope and spirit of the present disclosure, and the protection scope of the present disclosure will be defined by the claims.

What is claimed is:

1. A drying apparatus comprising:
an upper drying part comprising a first drying nozzle which is formed above an object to be dried and which extends along a width direction of the object to be dried, the upper drying part comprising a second drying nozzle formed on a same surface as the first drying nozzle; and
a lower drying part comprising a lower drying nozzle which is formed below the object to be dried and which extends along the width direction of the object to be dried,
wherein the first drying nozzle and the second drying nozzle are configured to dry the object to be dried with different heat sources.

2. The drying apparatus of claim 1, wherein the first drying nozzle comprises a hot air heater, and the second drying nozzle comprises an infrared heater.

3. The drying apparatus of claim 2, wherein the second drying nozzle comprises at least one second division nozzle divided along the width direction of the object to be dried.

4. The drying apparatus of claim 2, wherein the lower drying nozzle is formed in a direction facing the first drying nozzle.

5. The drying apparatus of claim 1, further comprising a shielding adjustment part formed between the object to be dried and the upper drying part, the shield adjustment part comprising:
a guide rail formed in a width direction and a longitudinal direction of the upper drying part; and
a shielding plate configured to shield a portion or all of a space between the object to be dried and the first drying nozzle or between the object to be dried and the second drying nozzle along the guide rail.

6. The drying apparatus of claim 5, wherein the shielding plate is formed such that at least one shielding plate configured to shield a first end or a second end of the object to be dried by being moved in a longitudinal direction of the second drying nozzle is provided.

7. The drying apparatus of claim 5, wherein the shielding plate is formed such that a width of the shielding plate is larger than a width of the first drying nozzle or a width of the second drying nozzle.

8. The drying apparatus of claim 2, wherein a width of the first drying nozzle is formed from 150 mm to 250 mm, a width of the second drying nozzle is formed from 130 mm to 180 mm, and a width of the lower drying nozzle is formed from 150 mm to 250 mm.

9. The drying apparatus of claim 2, wherein the second drying nozzle comprises a second division nozzle that is divided as a plurality of second division nozzles in the width direction of the object to be dried, and comprises a second single nozzle integrally formed in the width direction of the object to be dried, and
the second single nozzle and the second division nozzle are alternately formed between each first drying nozzle.

10. The drying apparatus of claim 9, wherein the plurality of second division nozzles is individually controlled for each position according to a drying state of the object to be dried.

11. The drying apparatus of claim 9, wherein the plurality of second division nozzles is formed by being spaced apart from each other,
the second division nozzles are formed so as to respectively correspond to a first side and a second side of the first drying nozzle, and
the plurality of second division nozzles formed on a direction in the first side of the first drying nozzle is simultaneously controlled to be operated with a same output and the plurality of second division nozzles formed on a direction in the second side of the first drying nozzle is simultaneously controlled to be operated with a same output.

12. The drying apparatus of claim 10, wherein a length of the first drying nozzle in the width direction of the object to be dried is formed 1.5 times to 2 times a length of the second division nozzle in the width direction of the object to be dried.

13. A drying apparatus comprising an upper drying part comprising a first drying nozzle which is formed above an object to be dried and which extends along a width direction of the object to be dried, the upper drying part comprising a second drying nozzle which is formed on a same surface as the first drying nozzle and which is formed of a heat source different from the first drying nozzle,
wherein the second drying nozzle comprises a single drying nozzle on a first side in the width direction of the object to be dried and a multi-drying nozzle on a second side in the width direction of the object to be dried, and the single drying nozzle and the multi-drying nozzle are formed such that the single drying nozzle and the multi-drying nozzle are alternately arranged on the first side and the second side in a longitudinal direction of the object to be dried.

14. The drying apparatus of claim 13, wherein the second drying nozzle is arranged alternately with the first drying nozzle,
the single drying nozzle and the multi-drying nozzle that are formed in the first side in the width direction of the object to be dried along a first direction are controlled to be operated with a same output, and
the single drying nozzle and the multi-drying nozzle that are formed in the second side in the width direction of the object to be dried along the first direction are controlled to be operated with a same output.

15. The drying apparatus of claim 14, wherein the single drying nozzle comprises a single infrared heater and the multi-drying nozzle comprises at least two infrared heaters, and
the single drying nozzle and the multi-drying nozzle are formed by a same distance in a moving direction of the object to be dried.
